(19) United States
(12) Patent Application Publication
(10) Pub. No.: US 2004/0111746 A1
(43) Pub. Date: Jun. 10, 2004

(54) IP to DVB subchannel mapping

(76) Inventor: Khoi Hoang, Pleasanton, CA (US)

Correspondence Address: Tamiz Khan Esq., Prediwave Corporation, 48431 Milmont Drive, Fremont, CA, 94538, US

(21) Appl. No.: 10/310,690

(22) Filed: Dec. 4, 2002

(51) Int. Cl. H04N 7/16; G06F 13/00; H04N 5/445; G06F 3/00

(52) U.S. Cl. 725/54; 725/139; 725/136; 725/146

(57) ABSTRACT

The present invention teaches a broadcast server apparatus for transmitting data files to a large number of recipients over a wide area network comprising; a server for providing digital data files, the digital data files including a plurality of data packets; a packet identifier (ID) encapsulator unit for assigning PID values to each data packet such that a receiver may filter the data files in response to the PID values; a transmitter for transmitting the plurality of data packets over a transmission medium. Another embodiment teaches a method of encoding digital video broadcast (DVB) data files for broadcast comprising the acts of: parsing at least one data file into a sequence of data packets, the sequence being composed of a plurality of data packet containing digital data, wherein each data packet includes an identifier; and encoding each of the data packets with a PID value responsive to the identifier.

### BACKGROUND OF THE INVENTION

1. Field of the Invention

The present invention relates to digital information broadcast technology. In particular, the present invention teaches a method and apparatus for encoding digital data with IP addresses in order to efficiently broadcast the video data to end users having an appropriate decoding device.

2. Description of the Prior Art

A variety of digital data broadcast systems are available for providing digital data services to clients through set top boxes (STB), for display on a television or other video display devices such as computer monitors. The most advanced of these are the DVB (Digital Video Broadcast) services. One problem faced in such systems is that conventional DVB broadcast transmissions are not suited to being routed to destinations over conventional wide area networks. Bi-directional communications devices such as computers connected to the Internet allow for digital data services to be sent to individual clients. However, this requires significant processing and bandwidth resources and would not work in uni-directional systems. Additionally, such bi-directional systems require transmission bandwidth in proportion to the number of clients using the service at any one time.

The following is a general discussion of widely used digital broadcast systems. Generally in digital broadcast systems, a bit stream, multiplexed in accordance with the MPEG-2 standard, is a “transport stream” constructed from “packetized elementary stream” (or PES) packets and packets containing other necessary information. A “packetized elementary stream” (or PES) packet is a data structure used to carry “elementary stream data.” An “elementary stream” is a generic term for one of (a) coded video, (b) coded audio, or (c) other coded bit streams carried in a sequence of PES packets with one stream ID. Transport streams support multiplexing of video and audio compressed streams from one program with a common time base.

PRIOR ART FIG. 1 illustrates the packetizing of compressed video data 106 of a video sequence 102 into a stream of PES packets 108, and then, into a stream of transport stream packets 112. Specifically, a video sequence 102 includes various headers 104 and associated compressed video data 106. The video sequence 102 is parsed into variable length segments, each having an associated PES packet header 110 to form a PES packet stream 108. The PES packet stream 108 is then parsed into segments, each of which is provided with a transport stream header 114 to form a transport stream 112. Transport packets 188 carry the video data to data receivers.

Each transport packet stream header 114 includes a packet identifier (PID) indicating the stream to which a corresponding transport packet belongs. A digital video data receiving would be able to decode a PID in order to determine the proper transport stream for the packet. An MPEG-2 PID is a 13 bit sequence. The PID can be used to differentiate between different broadcast programs having unique PIDs.

PRIOR ART FIG. 2 is a block schematic showing a digital broadcast system 200 including a digital broadcast server 202 and a set-top-box 204 suitable for processing digital broadcast data. At the digital broadcast server 202, video data is provided to a video encoder 206 which encodes the video data in accordance with the MPEG-2 standard. The video encoder 206 provides encoded video 208 to a packetizer 210 which packetizes the encoded video 208. The packetized encoded video 212 provided by the packetizer 210 is then provided to a transport stream multiplexer 214.

Similarly, at the digital broadcast server 202, audio data is provided to an audio encoder 214 which encodes the audio data. The audio encoder 214 provides encoded audio 218 to a packetizer 220 which packetizes the encoded audio 218. The packetized encoded audio 222 provided by the packetizer 220 is then provided to the transport stream multiplexer 214.

The transport stream multiplexer 214 multiplexes the encoded audio and video packets and transmits the resulting multiplexed stream to a set-top-box 204 via distribution infrastructure 224. This distribution infrastructure 224 may be, for example, a telephone network and/or a cable TV (CATV) system, employing optical fiber and implementing asynchronous transfer mode (ATM) transmission protocols. At the set-top-box 204, on a remote end of the distribution infrastructure 224, a transport stream demultiplexer 230 receives the multiplexed transport stream. Based on the packet identification number of a particular packet, the transport stream demultiplexer 230 separates the encoded audio and video packets and provides the video packets to a video decoder 232 via link 238 and the audio packets to an audio decoder 236 via link 240.

The transport stream demultiplexer 230 also provides timing information to a clock control unit 236. The clock control unit 236 provides timing outputs to the both the video decoder 232 and the audio decoder 236 based on the timing information provided by the transport stream demultiplexer 230 (e.g., based on the values of PCR fields). The video decoder 232 provides video data which corresponds to the video data originally provided to the video encoder 206. Similarly, the audio decoder 236 provides audio data which corresponds to the audio data originally provided to the audio encoder 216.

PRIOR ART FIG. 3 shows a simplified functional block diagram of a digital video broadcast satellite (DVB-S) system 300. At the heart of the digital broadcast system 300 is the DVB-S server 302 which produces data streams corresponding to multiple virtual subchannels. The virtual subchannels are referred to as “virtual” because they do not necessarily occupy independent bandwidth. Commonly these data streams are made up of streaming video data formatted using an MPEG-2 video format. Generally transport packets corresponding to each virtual subchannel will have a PID value that also corresponds to that subchannel in order to allow DVB-S receivers to distinguish between the virtual subchannels.

The streaming data is supplied to an IP addressing module 304 which addresses each transport packet with an IP address. The IP address enables the transport packet to travel to an intended destination. The steaming data is then provided to a quaternary phase shifting key (QSPK) modulator and upconverter unit 306 where the transport packets are modulated and transmitted via a satellite transmitter and to an end user satellite dish 310 via relay satellite 308. The data is “addressed” to a user via the assigned IP address. A set top box receiver (STB) 312 receives the data and decodes the signal and filters the streaming data in order to separate the multiple virtual subchannels. The STB then displays video data corresponding to a selected virtual subchannel to the client.

In accordance with a typical DVB-S system virtual subchannels would include broadcast channels such as CNN, NBC, CBS, CSPAN, local television channels, HBO, Showtime, etc., each virtual subchannel having a corresponding PID value allowing an STB to distinguish between the subchannels.

PRIOR ART FIG. 4 illustrates a typical DVB broadcast channel 350 including multiple virtual subchannels. Each virtual subchannel has an individual PID value that is contained in each transport packet header of the streaming data of that virtual subchannel.

Digital Satellite TV (DVB-S) is the most advanced DVB delivery systems. A typical satellite channel has 36 MHz bandwidth, which may support transmission at up to

Mbps using Quadrature Phase Shift Keying modulation. DVB-S uses fixed sized MPEG-2 transport packets grouped into 8 packet frames. One problem with conventional DVB and DVB-S is that they include no mechanism for providing data-on-demand (DOD) services. Another problem with DVB-S is that the IP addresses of transport packets have no relationship to the PID values of each packet. This prevents receivers from filtering based on such PID/IP relationships.

As the above discussion reflects, none of the prior art systems provide digital data files to a large number of clients over a wide area network by mapping each data packet's IP value to a corresponding PID value. Therefore, it is desirable to provide a DOD digital data transmission system capable of providing efficient DVB transmissions using conventional wide area network infrastructure. It is also desirable to provide a system and method for receiving digital data files formatted by varying digital data standards such as MPEG-2 and various other standards. Furthermore, it would be advantageous to have a systematic mechanism for assigning a PID value indicative of an IP address value to enable the DVB data to be processed by a receiving STB, wherein the IP address is also indicative of the nature of the DVB data.

### SUMMARY

The present invention teaches a systematic method for assigning a PID value indicative of a data packet IP address to enable the DVB data to be processed by a receiving STB, wherein the IP address is also indicative of the nature of the DVB data. The present invention teaches a PID encapsulator module that can be used with existing cable broadcasting systems to send digital data files via satellite by attaching PID values to each data packet in order to enable satellite broadcast of data-on-demand (DOD) data files. The present invention teaches a method for encoding DVB digital data files with PID values corresponding to both the identity of the DVB data file or subchannel upon which it is transmitted and the IP address of the receiving client. The present invention also teaches a system and method for receiving digital data files formatted either as DOD data or as “streaming” digital data. The present invention includes a universal digital data system, an intelligent STB, and a variety of methods for handling these digital services and controlling the intelligent STB.

A first embodiment of the present invention teaches a broadcast server apparatus for transmitting data files to a large number of recipients over a wide area network comprising; a server for providing digital data files, the digital data files including a plurality of data packets; a packet identifier (PID) encapsulator unit for assigning PID values to each data packet such that a receiver may filter the data files in response to the PID values; a transmitter for transmitting the plurality of data packets over a transmission medium.

The method may further include transmitting an electronic program guide (EPG), wherein a user may select a desired data file using the electronic program guide.

A second embodiment teaches a method of encoding digital video broadcast (DVB) data files for broadcast comprising the acts of: parsing at least one data file into a sequence of data packets, the sequence being composed of a plurality of data packet containing digital data, wherein each data packet includes an identifier; and encoding each of the data packets with a PID value responsive to the identifier.

Another embodiment teaches a method of receiving data files, using an intelligent STB comprising: receiving a plurality of data packets including a first plurality of data packets corresponding to a selected subchannel of data via a transmission medium, wherein each data packet includes an identifier indicative of the selected subchannel; filtering the plurality of data packets in response to the identifier in order to retrieve the first plurality of data packets; decode the first plurality of data packets in order to reconstruct at least one selected data file

It is important to remark that as types of set-top boxes become more ubiquitous, they are often built-in to a unit, such as a TV or computer, rather than actually set on top or beside. One of ordinary skill in the art would recognize that all references to STBs would apply equally to built-in version, and thus the two become synonymous.

### BRIEF DESCRIPTION OF THE DRAWINGS

PRIOR ART FIG. 1 illustrates pictorially the packetizing of compressed video data into a stream of packets and a stream of transport packets;

PRIOR ART FIG. 2 illustrates by block diagram a system according to the MPEG-2 standard;

PRIOR ART FIG. 3 illustrates a simplified functional block diagram of a digital video broadcast satellite (DVB-S) system;

PRIOR ART FIG. 4 illustrates a typical DVB broadcast channel including multiple virtual subchannels;

FIG. 5A illustrates the architecture for a digital video broadcast (DVB) system in accordance with one embodiment of the present invention;

FIG. 5B illustrates the architecture for a digital video broadcast (DVB) system including both a conventional digital cable server and a client generic data-on-demand (DOD) broadcast server in accordance with one embodiment of the present invention;

FIG. 6 illustrates an exemplary video-on-demand (VOD) broadcast system in accordance with one embodiment of the present invention;

FIG. 7 illustrates a transport packet IP address to packet identifier (PID) value mapping process in accordance with one embodiment of the present invention;

FIG. 8 illustrates an exemplary mapping of IP address values to corresponding PID values in accordance with one embodiment of the present invention;

FIG. 9 illustrates a client receiver system in accordance with one embodiment of the present invention;

FIG. 10 illustrates an intelligent STB process for receiving DVB data in accordance with one embodiment of the present invention; and

FIG. 11 is a flow chart diagram illustrating an intelligent STB process for receiving DVB data in multiple transmission formats in accordance with one embodiment of the present invention.

### DETAILED DESCRIPTION OF THE PREFERRED EMBODIMENTS

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

The present invention teaches a systematic method for assigning a PID value indicative of a data packet IP address to enable the DVB data to be processed by a receiving STB, wherein the IP address is also indicative of the nature of the DVB data. The present invention teaches a PID encapsulator module that can be used with existing cable broadcasting systems to send digital data files via satellite by attaching PID values to each data packet in order to enable satellite broadcast of data-on-demand (DOD) data files. The present invention teaches a method for encoding DVB digital data files with PID values corresponding to both the identity of the DVB data file or subchannel upon which it is transmitted and the IP address of the receiving client. The present invention also teaches a system and method for receiving digital data files formatted either as DOD data or as “streaming” digital data. The present invention includes a universal digital data system, an intelligent STB, and a variety of methods for handling these digital services and controlling the intelligent STB. However, those skilled in the art will recognize that all aspects of the present invention can be implemented within the bi-directional communication paradigm, the only difference being that even more features can be provided to a user when a bi-directional communication link is available.

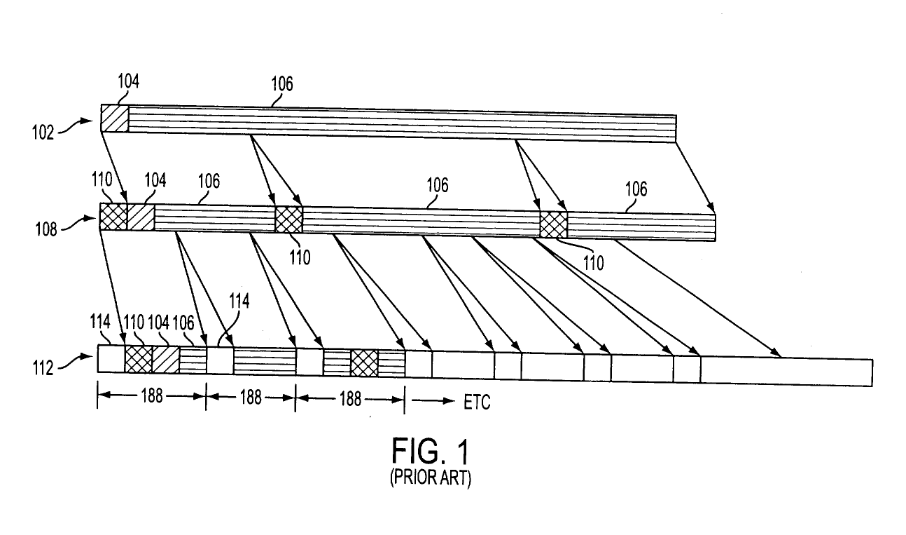

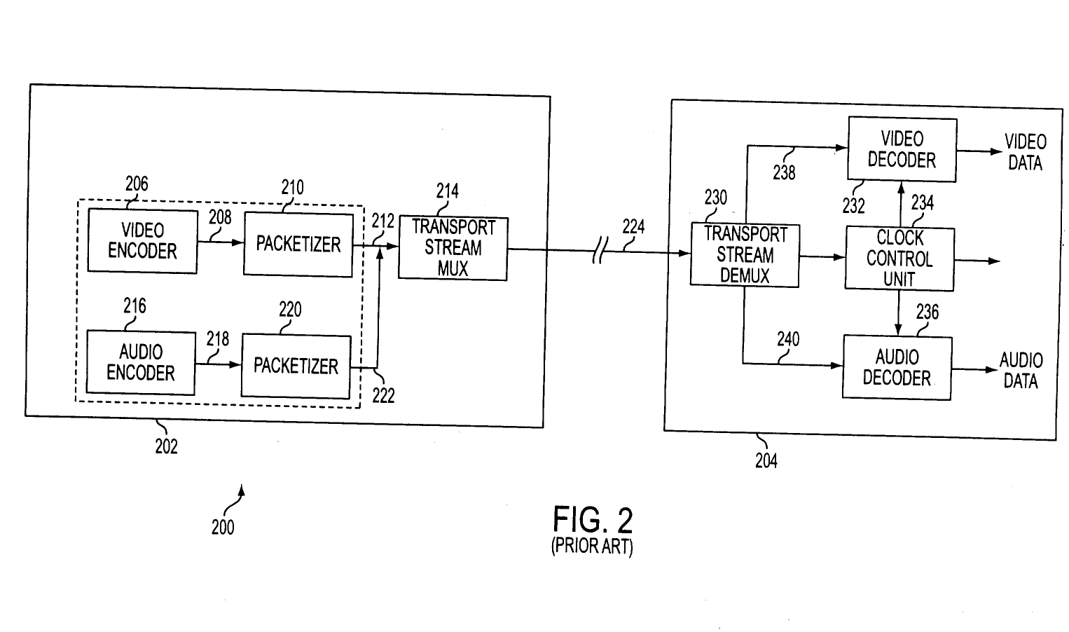

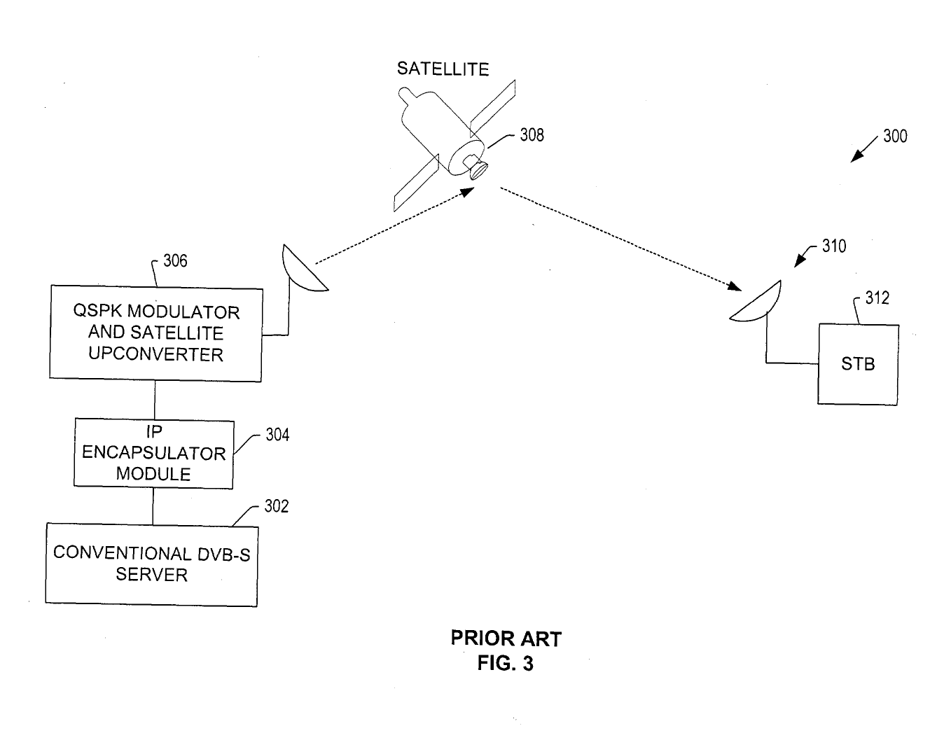

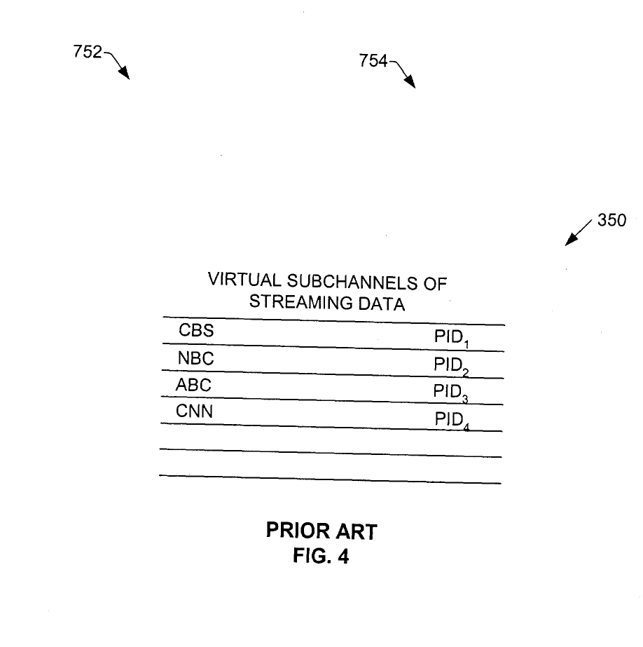

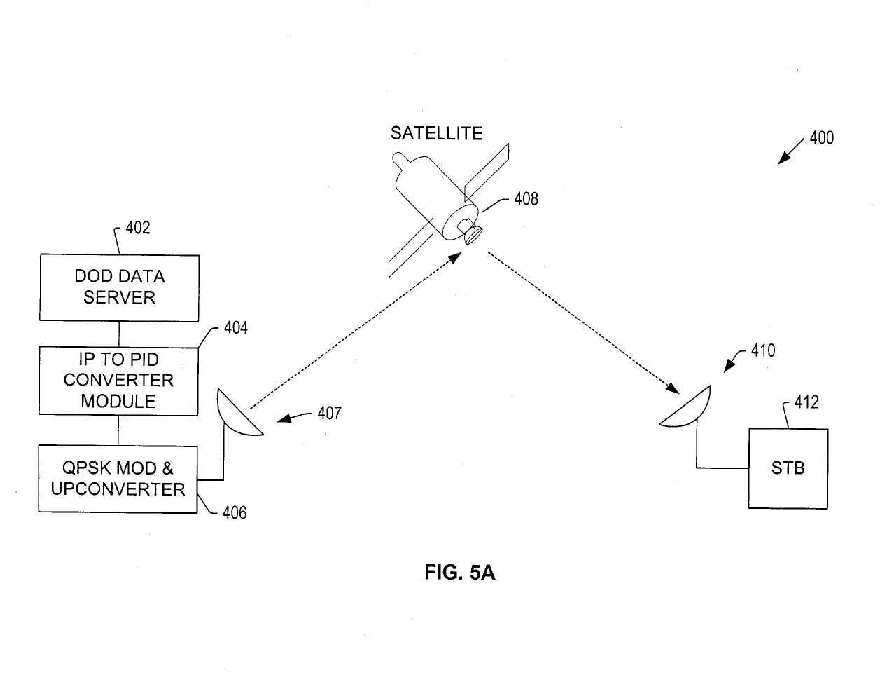

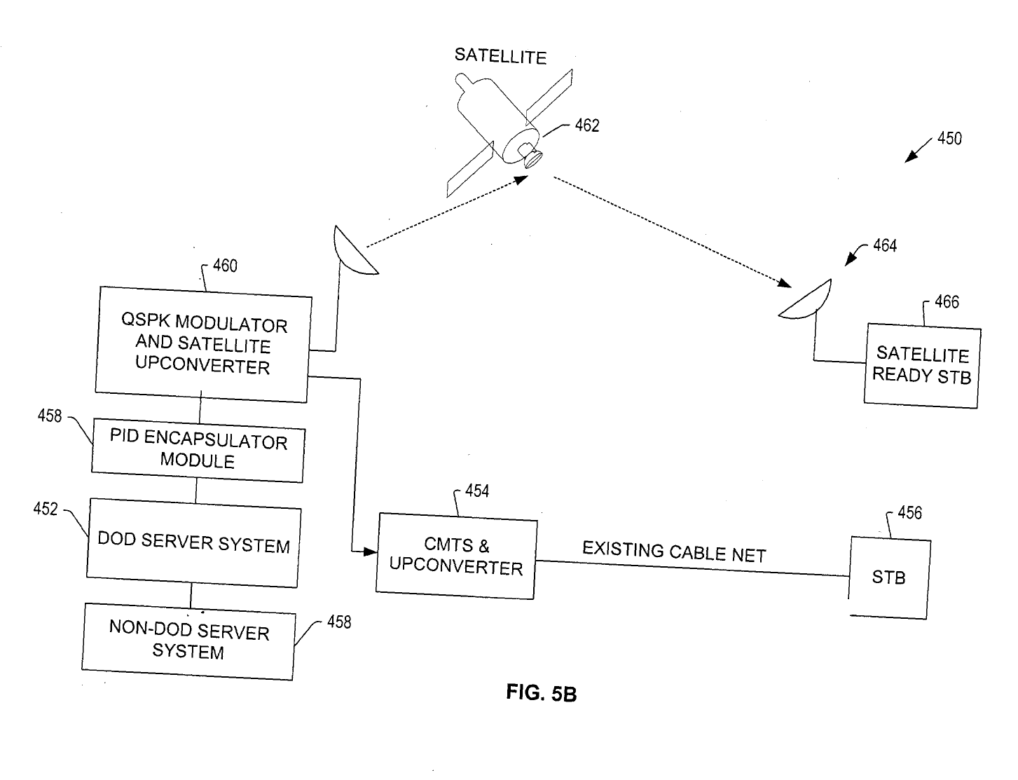

FIG. 5A illustrates the architecture for a digital video broadcast (DVB) system 400 in accordance with one embodiment of the present invention. The DVB system 400 includes a data-on-demand (DOD) server 402 that provides multiple virtual subchannels of video-on-demand (VOD) data in an MPEG-2 format to an IP to PID converter module 404. Each virtual subchannel is composed of MPEG-2 data packets corresponding either to DOD data file or a TV broadcast channel, etc. The data packets are transmitted out of sequence in order to enable on-demand viewing. This method of providing uni-direction DOD data is taught by Khoi Nhu Hoang's patent applications entitled UNIVERSAL STB ARCHITECTURES AND CONTROL METHODS filed on May 30, 2001, SYSTEMS AND METHODS FOR PROVIDING VIDEO ON DEMAND SERVICES FOR BROADCASTING SYSTEMS filed on May 31, 2000, bearing application Ser. No. 09/584,832, METHODS FOR PROVIDING VIDEO ON DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, all three being incorporated herein by reference.

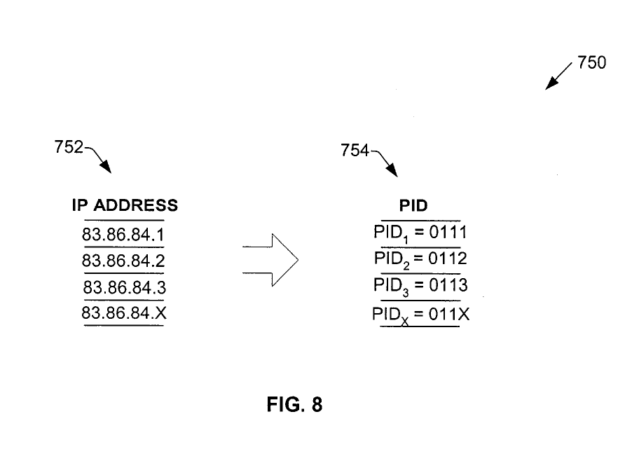

The MPEG-2 data is made up of transport packets each having an IP address indicative of either the DOD data file or the television broadcast channel (NBC, CBS, CNN, etc.) the data packet belongs to. The IP to PID converter 404 recieves the transport packets and assigns a PID value to the header of each transport packet corresponding to the packet's IP address value. The specific algorithm used to generate the corresponding PID value should generate a single valid PID value that is unique to each valid IP address value of each incoming transport packet. This is discussed in more detail with respect to FIG. 8.

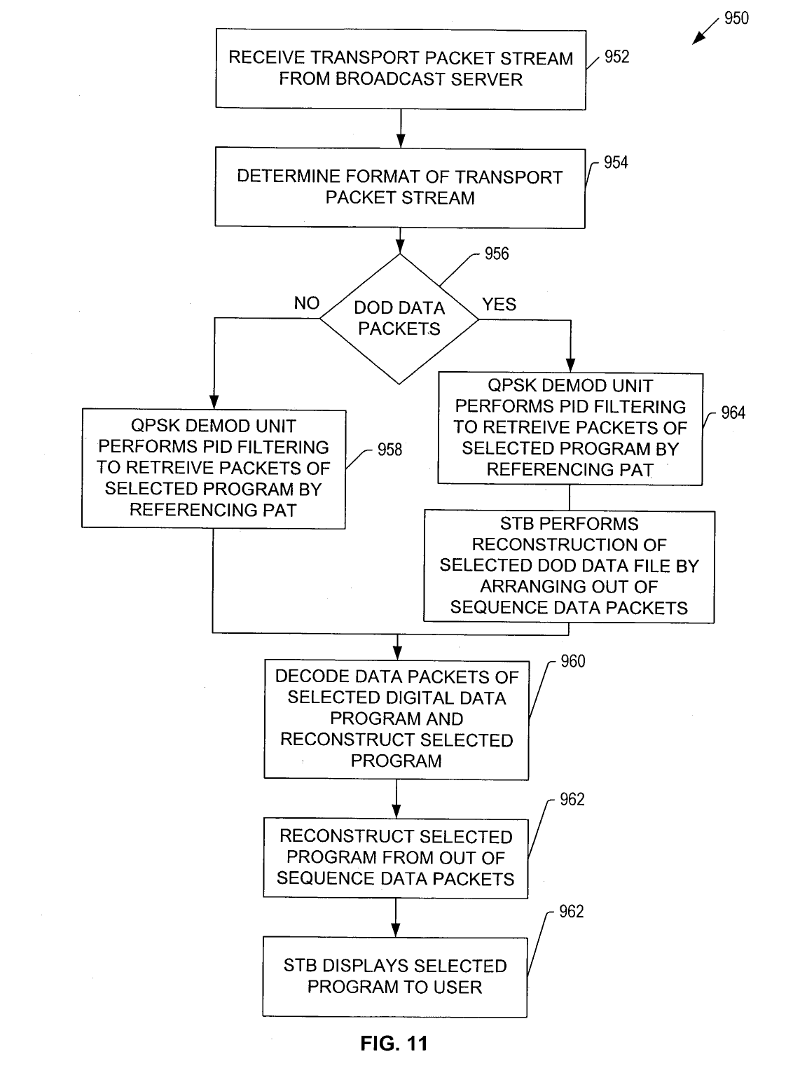

The transport packets are then transmitted to a quaternary phase shifting key (QSPK) modulator and upconverter unit 406 where the transport packets are modulated and transmitted to a satellite transmitter 407 which transmits the data packets to an end user satellite dish 410 via relay satellite 408. The data is “addressed” to a user via the assigned IP address. A universal set top box receiver (STB) 412 receives the data and decodes the signal and displays any desired video data to the client. This process is described with reference to FIG. 11.

FIG. 5B illustrates the architecture for a digital video broadcast (DVB) system at 450 for transmitting both VOD and non-VOD over either existing cable infrastructure or satellite in accordance with one embodiment of the present invention. The DVB system 450 includes a conventional digital cable server system 458 that provides multiple virtual subchannels of streaming video data in an MPEG-2 format. The streaming data of the conventional server is made up of MPEG-2 transport packets transmitted in sequence for viewing by a client.

The DVB system 450 also includes a data-on-demand (DOD) server system 452 that provides data packets of VOD data files in an MPEG-2 format. Unlike the conventional server 458, the DOD server 452 provides data packets of data files out of sequence in order to enable on-demand viewing of the data files. This system and method of providing and deciphering uni-direction DOD data is taught by Khoi Nhu Hoang's patent applications entitled UNIVERSAL STB ARCHITECTURES AND CONTROL METHODS filed on May 30, 2001, SYSTEMS AND METHODS FOR PROVIDING VIDEO ON DEMAND SERVICES FOR BROADCASTING SYSTEMS filed on May 31, 2000, bearing application Ser. No. 09/584,832, METHODS FOR PROVIDING VIDEO ON DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, all three being incorporated herein by reference.

In order to allow future identification of the data packets of any selected VOD data file, each VOD data file has a unique IP address assigned to it, and each data packet containing part of the VOD data file also has the unique IP address. Because the VOD data is not “streaming data” conventional set-top-box (STB) receivers will be unable to decipher the VOD data.

The out of sequence data of the VOD server 452 is transmitted to a PID encapsulator module 458. The PID encapsulator assigns a PID value to each data packet by mapping the data packet's IP address to a corresponding PID value. The specific algorithm used to generate the corresponding PID value should generate a single valid PID value that is unique to each valid IP address value of each incoming transport packet. This is discussed in more detail with respect to FIG. 8.

The VOD data packets and non-VOD data packets are received by a quaternary phase shifting key (QSPK) modulator 458 where it is modulated for transmission over limited bandwidth. Appropriate methods for performing QSPK modulation on packetized data would be apparent to those skilled in the DVB field. The data is then sent to an upconverter and cable modem termination system (CMTS) unit 460 for transmission to cable boxes 462 via cable television network infrastructure.

In accordance with one embodiment of the present invention QSPK modulator 458 also transmits the quad modulated data stream to satellite upconverter 464 where the signal is converted for satellite transmission to satellite dish 466 via relay satellite 468. Specific methods for transmitting such data via satellite would be apparent to one skilled in such technology and are not within the purview of the present invention.

A universal set top box receiver (STB) 470 or 462 decodes the modulated signal and displays any desired video data to the client. The STB 470/462 is able to receive either VOD or standard “streaming” MPEG-2 data by filtering the PID values of transport data packets. This process is described with reference to FIG. 11.

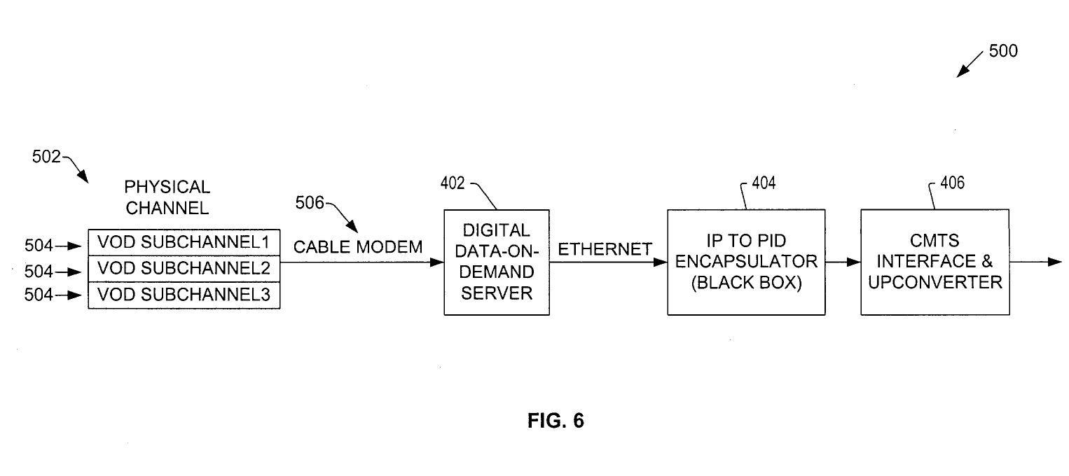

FIG. 6 illustrates an exemplary DVB broadcast system at 500 in accordance with one embodiment of the present invention. VOD programs are provided via a physical channel 502 composed of multiple VOD subchannels 504. Generally each VOD subchannel 504 will carry one or more VOD programs composed of a stream of out of sequence data packets such that the VOD programs can be viewed “on-demand” by a client. Methods for providing such sequences of DOD data packets are taught by Khoi Nhu Hoang's various patent applications referred to in the description of FIGS. 5A and 5B. Physical channel 502 is generally a narrow bandwidth signal carried either by fiber optic cable or electrical cable.

A cable modem 506 is used to transmit physical channel signal 502 to DOD server 508. DOD server 508 converts video (and any other appropriate media such as audio and text) data carried by VOD subchannels 504 into MPEG-2 formatted data transport streams made up of data packets. Server 508 assigns each of these MPEG-2 transport packets an IP address corresponding to a specific VOD program or VOD subchannel of origin.

In accordance with one embodiment data packets are assigned an IP address indicative of the VOD subchannel 504 the data packets came from. Thus, all data carried on subchannel 1 is assigned a unique IP address associated only with subchannel 1, transport packets containing data from subchannel 2 are assigned an IP address unique to subchannel 2, etc. Thereby, each subchannel is assigned a corresponding IP address by server 508.

In accordance with an alternative embodiment, the server 508 assigns a unique IP address corresponding to each distinct digital data program. Thus all data packets carrying data associated with the movie “Gone In 60 Seconds” would be assigned an IP address corresponding to that title.

The server 508 then provides the transport packets via an ethernet link to a PID (packet identifier) encapsulator 510 which assigns a PID value to each transport packet corresponding to the packet's IP address value. This PID value is unique to the corresponding IP address value such that each IP address value only corresponds to a single PID value. The PID encapsulator (black box) 510 applies a mapping function to each IP address value in order to generate a corresponding PID value. The exact algorithm used to generate the PID value may vary, but must generate a valid PID value. The PID encapsulator then transmits the modified data signal to the CMTS interface/upconverter 512.

The CMTS interface/up-converter 512 converts the signals received from the server to radio frequency signals (RF signals). The RF signals, which include frequency and bandwidth, are dependent on a desired channel and adopted standards. In accordance with one embodiment of the present invention the RF signal generated must be of a frequency and power appropriate for satellite broadcast.

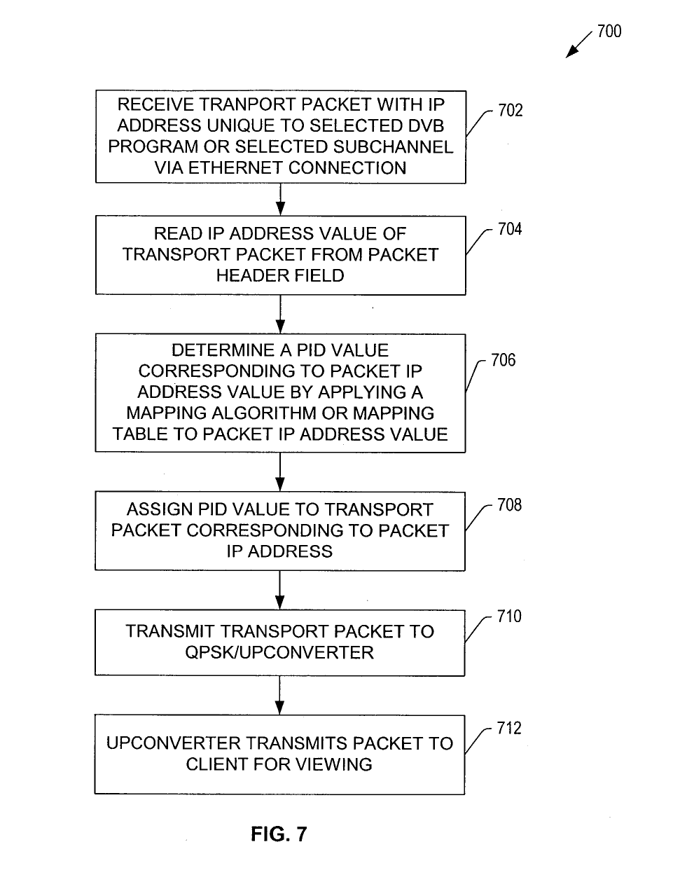

FIG. 7 illustrates a transport packet IP address to PID value mapping process at 700 in accordance with one embodiment of the present invention. The process 700 starts at a step 702 at which the PID encapsulator module 510 (FIG. 6) receives a transport packet with a packet IP address unique to a selected transport stream or selected digital data program from a server system 508 (FIG. 6)). The IP address value is contained within each transport packet header, and is unique to a selected transport stream (or in accordance with one embodiment is unique to each distinct digital data program available from the server). This transport packet is generally one of many transport packets of among multiple transmission streams transmitted via an ethernet connection or other suitable transmission medium from a server 508 (FIG. 6).

In step 704 PID encapsulator 508 (FIG. 6) reads the IP address value contained in header field of the received transport packet. Then in step 706 the PID encapsulator 510 determines a PID value that corresponds to the IP address value by mapping the IP address value to a corresponding PID value. This mapping may be accomplished either by an algorithm or by use of a mapping table, or by any other appropriate method. The specific implementation of such an algorithm or mapping table would be apparent to one skilled in the art. One such exemplary algorithm/mapping table is illustrated in and described with reference to FIG. 8 below.

In step 708 the encapsulator attaches this PID value to the transport packet such that the PID value may be used to process the transport packet by a receiving STB. In step 710 the PID encapsulator transmits the transport packet to a cable modem termination system 512 (FIG. 6). In step 712 the CMTS/Upconverter 512 transmits the transport packet via a transmission medium (such as satellite broadcast RF) to clients.

In accordance with one embodiment of the present invention, server 402 provides both client generic DOD services and client specific data services.

FIG. 8 illustrates an exemplary mapping of IP address values to corresponding PID values at 750 in accordance with one embodiment of the present invention. Column 752 contains IP address values for subchannels 1 through X designated as 83.86.84.1 through 83.86.84.X respectively. In accordance with the present example, each of the IP address values is mapped to a corresponding PID vlaue of table 754. Thus, an IP address of 83.86.84.1 is assigned a PID value of 0111, and each incrementally increasing IP address value is assigned a corresponding incrementally increasing PID value. The exemplary algorithm is a simple one and would only be viable for a DVB system using a limited number of channels.

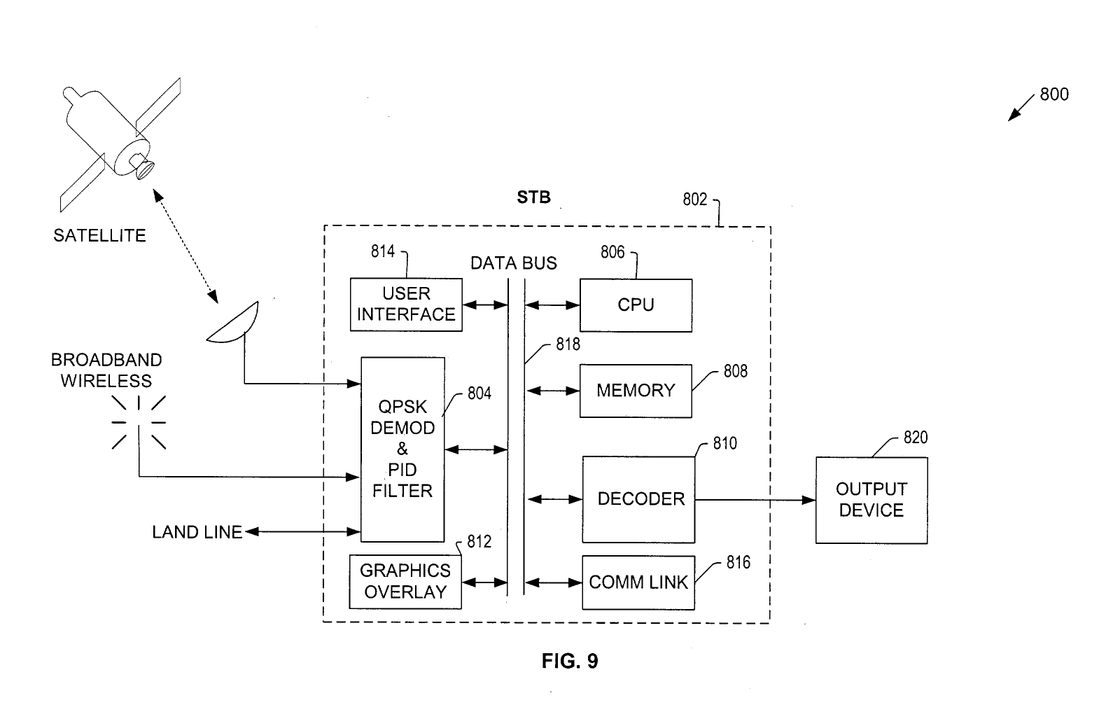

FIG. 9 illustrates a client receiver system at 800 in accordance with one embodiment of the invention. The client receiver system 800 includes an intelligent set-top-box (STB) 802 for receiving DVB data in a variety of formats. The STB 802 is also capable of deciphering and constructing uni-directional DOD data in accordance with one aspect of the present invention. Generally all data packets received by such an STB will be in a video format such as MPEG-2. STB 802 comprises: a QPSK demodulator/filter 804, a CPU 806, a local memory 808, a buffer memory (not shown), a decoder 810 having video and audio decoding capabilities, a graphics overlay module 812, a user interface 814, a communications link 816, and a fast data bus 818 coupling these devices as illustrated. Quaternary phase shifting key (QSPK) demodulator/PID filter 804 is operative to demodulate the transmission data stream and filter transport data packets by either PID value or IP address value. The CPU 806 controls overall operation of the intelligent STB 802 in order to select data in response to a client's request, decode selected data, decompress decoded data, re-assemble decoded data, store decoded data in memory 808, and deliver stored data to the decoder 810. In an exemplary embodiment, the memory 808 comprises both non-volatile memory (e.g., a hard drive) and secure memory (e.g., a ROM chip), and the buffer memory (not shown) comprises volatile memory. A hardware identification code (not shown) is stored in a secure memory location of the local memory 808, this code is unique to the STB 802 and cannot be readily altered.

In one embodiment, the quaternary phase shifting key (QSPK) demodulator/PID filter 804 comprises transmitter and receiver modules and one or more of the following: privacy encryption/decryption module, forward error correction decoder/encoder, tuner control, downstream and upstream processors, CPU and memory interface circuits. The QSPK demodulator/PID filter 804 is operative to demodulate the transmission data stream and filter transport data packets by either PID value or IP address value. The demodulator 804 is operative to filter data packets by excluding PID or IP address values that would contain extraneous data while retrieving packets with PID or IP address values expected to contain relevant or sought after data such as a movie selected for viewing by a user. Furthermore, in order to reduce processing operations extraneous packets having PID or IP address values corresponding to extraneous data are automatically discarded by the filter 804.

By being capable of receiving and demodulating either DVB formatted data or Internet protocol formatted data, the universal STB 802 is capable of receiving widely varying digital data services. In accordance with one embodiment, STB 802 is further operative to receive and decode analog broadcast TV, analog cable TV, radio transmissions, etc.

In accordance with one embodiment STB 802 is operative to store and update a directory of all PID and IP address values of services or subchannels provided by the DVB broadcast system. The STB being programmed to first read the PID field of any received data packet, and retrieve an IP value only if the PID field does not match any known PID value stored in memory. In accordance to one embodiment, the STB may then assume a PID value based on the IP value by referencing an IP/PID reference map.

In an exemplary embodiment, when accessed, the decoder 810 decodes digital data to transform the data into images and sounds displayable on an output device 820. The decoder 810 supports commands from a subscribing client, such as play, stop, pause, step, rewind, forward, etc. The output device 820 may be any suitable device such as a television, computer, any appropriate display monitor, a VCR, or the like.

The graphics overlay module 812 enhances displayed graphics quality by, for example, providing alpha blending or picture-in-picture capabilities. In an exemplary embodiment, the graphics overlay module 812 can be used for graphics acceleration during game playing mode, for example, when the service provider provides games-on-demand services using the system in accordance with the invention.

The user interface 814 enables user control of the STB 802, and may be any suitable device such as a remote control device, a keyboard, a smartcard, etc. The communications link 816 provides an additional communications connection. This may be coupled to another computer, or may be used to implement bi-directional communication. The data bus 818 is preferably a commercially available “fast” data bus suitable for performing data communications in a real time manner as required by the present invention. Suitable examples are USB, firewire, etc. Although services are broadcast to all cable television subscribers, only the subscriber who has an STB 802 authorized to view a selected service will be able to decode and enjoy the selected service.

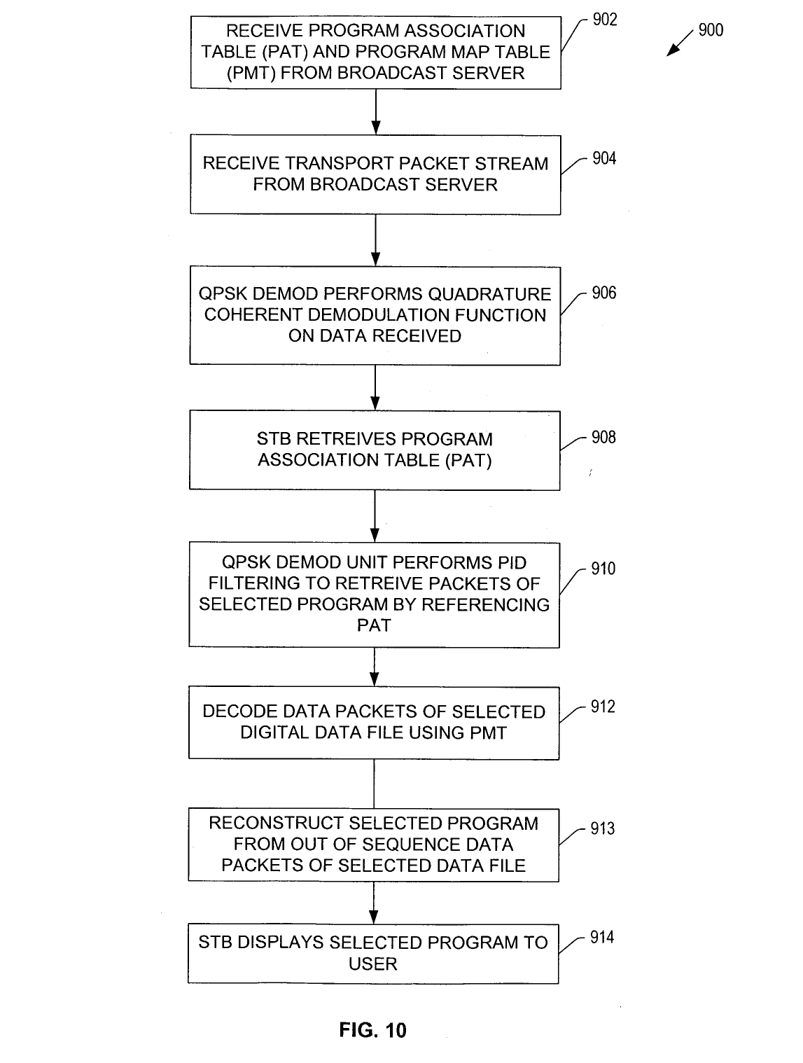

FIG. 10 illustrates an intelligent STB process at 900 for receiving DVB data in accordance with one embodiment of the present invention. The process 900 starts at a step 902 at which the STB 802 (FIG. 9) receives program association tables (PAT) and program map tables (PMT) from the DVB broadcast server system. In accordance with one embodiment the STB tunes to a predetermined channel and bandwidth dedicated for electronic program guide (EPG) data including PMTs and PATs. Generally EPG data includes information on all data files available from the server system.

In step 904 the STB receives a transport packet stream from the DVB broadcast server system addressed to the STB by IP addresses contained in the transport packet headers. In accordance with one embodiment the STB tunes into a bandwidth to which a desired transport stream is transmitted. In accordance with one embodiment of the present invention the STB is also capable of receiving DVB packet streams transmitted via both conventional direct transmission DVB formats such as MPEG-2 transport streams as well as internet protocol addressing formats. Thus, such an STB would be capable of receiving DVB broadcast data from multiple servers or servers using varying transmission methods (both IP addressed packets and conventional DVB transmissions).

In step 906 a quaternary phase shifting key (QSPK) demodulator/PID filter 804 (FIG. 9) performs quadrature coherent demodulation on the data packet in order to restore the data to a usable state. Such demodulation methods are established in the DVB industry and specific implementation of such demodulation would be within the capability of those skilled in the field.

In step 908 the STB retrieves a program association table (PAT) corresponding to a selected DVB file. In step 910 the QSPK demodulator/filter 804 (FIG. 9) filters the transport packets in order to retrieve the packets corresponding to the selected DVB file by retrieving all packets having the PID/PIDs indicated as belonging to the appropriate transport stream by the PAT. The specific implementation of PATs to filter packets based on PID values corresponding to selected data files has been well established in DVB technology incorporating the MPEG-2 video format.

In step 912 the STB decodes the DVB data. In step 913 the processor reconstructs the DVB file using a PMT corresponding to the selected DVB program. The use of PMTs to reconstruct DVB files is well established in the MPEG-2 technology, and specific implementation of such methods in accordance with the present invention would be within the purview of experts in the field. In the case of VOD DVB files the STB would also have to resequence the out of sequence data in accordance with the uni-directional DOD broadcast methods referenced with respect to FIG. 6 and taught by the patent applications also referenced with respect to FIG. 6.

In step 914 the STB displays the DVB data to the user as an audio/video presentation. Types of DVB programs may include video, audio or text. Video programs may include video games, movies, interactive movies, etc.

FIG. 11 illustrates an intelligent STB process at 950 for receiving either conventional DVB-S or unidirectional DOD data transmitted using multiple transmission formats in accordance with one embodiment of the present invention. The process 950 starts at a step 952 at which the STB 802 (FIG. 9) receives a transport packet stream from the DVB broadcast server system. In step 954 the STB determines the transmission method and format of the packet stream. If in step 956 the packet stream is in a conventional DVB format, the process continues to step 958 at which the QPSK unit filters the packet PID field values in order to retrieve packets of a selected DVB file. Since the packets are in sequence for viewing no complex packet processing is required. The conventional DVB packets are in a “streaming” format.

In step 960 the STB decodes the “streaming” DVB data and reconstructs the DVB file. In step 962 the STB displays the DVB data to the user as an audio/video presentation.

If in step 956 the packets are formatted as unidirectional DOD (as described in Khoi Hoang's patent applications referenced above and incorporated herein), the process continues to step 964 at which the QPSK unit performs PID filtering to retrieve the packets of the selected DVB file. Then in step 966 the STB performs a uni-directional DOD reconstruction process to recreate the selected DOD data file. Thus, the STB is capable of receiving digital data transmissions in both DVB and uni-directional client generic DOD formats. In accordance with an alternative embodiment of the present invention the STB receiver may also determine a PID value of a data packet by reading the data packet IP address by performing a reverse mapping function from IP address value to PID value. Such an embodiment could determine a PID value corresponding to a received IP address value by consulting an algorithm reversing the algorithm used in FIG. 8, for example.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of encoding digital video broadcast (DVB) data files for broadcast comprising the acts of:
parsing at least one data file into a sequence of data packets, said sequence being composed of a plurality of data packets containing digital data, wherein each data packet includes an IP address value; and
encoding each of said data packets with a packet identifier (PID) value responsive to said IP address value.

2. The method of claim 1 wherein said plurality of data packets is transmitted in a unidirectional data-on-demand (DOD) format such that a set-top-box (STB) receiver configured to receive uni-directional DOD data is operable to access said data file.

3. The method of claim 2 including transmitting an electronic program guide (EPG) to said STB reciever, wherein a user may select a selected data file using said electronic program guide.

4. The method of claim 1 wherein said PID value is responsive to the identity of a selected data file, wherein all data packets having a first PID value correspond to said selected data file.

5. The method of claim 1 wherein said at least one data file is a digital movie file including audio and visual data.

6. The method of claim 1 wherein at least one data file is a text file including textual information.

7. The method of claim 3 wherein said plurality data packets are transmitted on a single corresponding bandwidth, and wherein additional data packets corresponding to additional data files are transmitted on said single corresponding bandwidth.

8. The method of claim 2 wherein said plurality data packets are transmitted in a client generic manner to a plurality of destinations such that the bandwidth required for said transmission is independent of the number of said destinations and such that said data file may be accessed on demand by clients at said destinations.

9. A method of receiving data files, using an intelligent STB comprising:
receiving a plurality of data packets including a first plurality of data packets corresponding to a selected subchannel of data via a transmission medium, wherein each said data packet includes a identifier indicative of an IP address value;
filtering said plurality of data packets in response to said identifier in order to retrieve said first plurality of data packets;
decode said first plurality of data packets in order to reconstruct at least one selected data file.

10. The method of claim 9 wherein said first plurality of data packets are received in a sequence, and wherein said decoding includes rearranging said sequence such that said data packets are restored to an intended sequence.

11. The method of claim 9, further comprising displaying said at least one selected data file to a client.

12. The method of claim 9, further comprising receiving a program association table (PAT) via said transmission medium and referencing said PAT in order to filter said plurality of data packets and retrieve said first plurality of data packets.

13. The method of claim 9, further including the act of tuning to a transmission channel corresponding to said plurality of data packets, said transmission channel including a plurality of subchannels.

14. The method of claim 9, further including receiving an electronic program guide (EPG) program on a predetermined bandwidth, said EPG enabling said user to select a desired data file for viewing.

15. The method of claim 14, wherein said EPG bandwidth includes data indicating a bandwidth associated with said selected data file, and enables said STB to tune to said bandwidth associated with said selected data file.

16. The method of claim 15, wherein said EPG bandwidth carries said PAT and a program mapping table (PMT), wherein said PMT enables said STB to reconstruct said selected data file from said first plurality of data packets.

17. The method of claim 9 wherein said identifier is a packet identifier (PID) value.

18. The method of claim 9 wherein said identifier is an IP address value.

19. The method of claim 18, including receiving a PID reference file, said PID reference file including a plurality of PID values and a plurality of corresponding IP address values.

20. The method of claim 18 wherein said STB is operative to filter said plurality of data files in response to said packet identifier (PID).

21. The method of claim 20 wherein said STB is operative to filter said plurality of data files in response to said IP address.

22. A broadcast server apparatus for transmitting data files to a large number of recipients over a wide area network comprising;
a server for providing digital data files, said digital data files including a plurality of data packets;
a packet identifier (PID) encapsulator unit for assigning PID values to each said data packet in response to an IP address such that a receiver may filter said data files in response to said PID values; and
a transmitter for transmitting said plurality of data packets over a transmission medium.

23. A broadcast server method for transmitting digital data comprising:
attaching an packet identifier (PID) value to data to enable the data to be viewed at a destination, wherein the PID value is responsive to an IP address corresponding to said data.

24. The method of claim 23, wherein the data is digital video broadcast (DVB) data.

25. The method of claim 23, wherein the data is data-on-demand (DOD) data.

26. A method of encoding digital data for broadcast comprising the acts of:
receiving a sequence of data packets, said sequence being composed of a plurality of data packets containing digital data, wherein each data packet includes an identifier; and
encoding each of said data packets with an packet identifier (PID) value responsive to said identifier.

27. The method of claim 26 including transmitting said data packets to a data receiver, said data receiver being operative to decode said data packets in response to said PID value.

28. The method of claim 27 including transmitting an electronic program guide (EPG) to said data receiver, wherein a user may select a selected data file using said electronic program guide.

29. The method of claim 26 wherein said identifier is an IP address value, and wherein said IP address value corresponds to a selected data file, wherein all data packets having a first PID value correspond to said selected data file.

30. The method of claim 29 wherein an icon corresponding to said selected data file is displayed via the EPG such that a user may select the data file by selecting the displayed icon.

31. The method of claim 27 wherein said plurality of data packets are transmitted on a single corresponding bandwidth, and wherein additional data packets corresponding to additional data files are transmitted on said single corresponding bandwidth.

32. The method of claim 27 wherein said plurality data packets are transmitted in a client generic manner to a plurality of destinations such that the bandwidth required for said transmission is independent of the number of said destinations and such that said data file may be accessed on demand by clients at said destinations.

33. An packet identifier (PID) encapsulator unit for assigning PID values to data packets comprising:
an apparatus for receiving a plurality of data packets, each data packet having an identifier; and
a PID mapping processor operative for assigning a PID value to each said packet at least partially responsive to said identifier.

34. The apparatus of claim 33, wherein said identifier is an IP address value.

35. A digital data receiver for receiving digital data files comprising:
a communications port for receiving a plurality of data packets, each data packet having at least one identification code, wherein said identification code is responsive to an IP address value;
a filter for retrieving selected data packets in response to said identification code;
a decoder for reading data included in said selected data packets; and
a processor for reconstructing selected data files from said data.

36. The apparatus of claim 35, wherein said digital data receiver is a set-top-box (STB) operative to display said selected data files via a video monitor.

37. The apparatus of claim 36, wherein said video monitor is a television.
